(19) United States
(12) Patent Application Publication
(10) Pub. No.: US 2013/0154410 A1
(43) Pub. Date: Jun. 20, 2013

(54) HYBRID AUTOMOBILE

(71) Applicants: Masao Morita, Tokyo (JP); Masaya Inoue, Tokyo (JP); Yoichi Kuroda, Tokyo (JP)

(72) Inventors: Masao Morita, Tokyo (JP); Masaya Inoue, Tokyo (JP); Yoichi Kuroda, Tokyo (JP)

(73) Assignee: Mitsubishi Electric Corporation, Tokyo (JP)

(21) Appl. No.: 13/820,595

(22) PCT Filed: Aug. 29, 2011
(86) PCT No.: PCT/JP2011/069429

§ 371 Date: Mar. 4, 2013

(30) Foreign Application Priority Data
Sep. 3, 2010 (JP) 2010-197486

(51) Int. Cl. H02K 5/04; H02K 3/50

(52) U.S. Cl. CPC H02K 5/04; H02K 3/50; Y10S 903/902
USPC 310/71; 310/91; 180/65.21; 903/902

(57) ABSTRACT

In this hybrid automobile, a stationary field rotary electric machine is disposed between an engine unit and a transmission unit such that a rotor is linked directly to a crankshaft of the engine unit. A static yoke portion is disposed inside the rotor from a side near the transmission unit such that a field winding is positioned radially inside first and second claw-shaped magnetic pole portions, and a static yoke portion mounting pedestal holds an end portion of a large diameter portion of the static yoke portion near the transmission unit. A radial width of the field winding is narrower than a radial width of a small diameter portion of the static yoke portion onto which the field winding is mounted.

### TECHNICAL FIELD

The present invention relates to a hybrid automobile that includes a rotary electric machine in which a field winding is mounted into a static yoke portion, and particularly relates to a construction for mounting a rotary electric machine that is interposed between an engine unit and a transmission unit.

### BACKGROUND ART

Conventional engine starting and charging apparatuses include a brushless motor that is directly connected to an output shaft of an engine, and the brushless motor is operated so as to start the engine when a starting operation is performed, to accelerate the engine when in an accelerating state, and to generate electric power when the starting operation is stopped, and when out of the accelerating state (see Patent Literature 1, for example).

In conventional engine starting and charging apparatuses, the brushless motor includes: a cylindrical first rotor and an annular second rotor in which tooth portions intermesh with each other, that are linked by a nonmagnetic ring; a field winding that is wound onto an annular field core, and that is housed in an annular recess portion that is formed on an inner circumferential portion of the tooth portions of the first rotor; an armature core that is disposed on outer circumferential portions of the tooth portions of the first and second rotors in an annular shape so as to have a predetermined clearance; and an armature winding that is mounted into the armature core, the brushless motor being mounted by fixing the first rotor to a crankshaft of the engine, by fixing the field core to a cylinder block of the engine, and by fixing the armature core to a transmission case.

### CITATION LIST

### Patent Literature

Patent Literature 1: Japanese Patent Laid-Open No. SHO 61-38161 (Gazette)

### SUMMARY OF THE INVENTION

### Problem to be Solved by the Invention

In conventional engine starting and charging apparatuses, because the field core is fixed to the cylinder block of the engine, one problem has been that heat generated in the engine is transferred to the field winding through the field core, making the temperature in the field winding rise excessively.

The present invention aims to solve the above problems and an object of the present invention is to provide a hybrid automobile that can suppress excessive temperature increases in a field winding by disposing a static yoke portion onto which the field winding is wound near a transmission unit to suppress amounts of heat that are transferred from an engine unit through the static yoke portion to the field winding.

### Means for Solving the Problem

In order to achieve the above object, according to one aspect of the present invention, there is provided a hybrid automobile including an internal combustion engine and a stationary field rotary electric machine as a motive driving source, and a transmission that outputs one or both driving forces from the internal combustion engine and the stationary field rotary electric machine to a drive shaft. The stationary field rotary electric machine includes: a frame; an armature that is fixed to the frame and that is disposed inside the frame; a rotor that is disposed inside the armature, and that is formed such that a plurality of magnetic poles that are magnetized by a magnetomotive force are arranged circumferentially on an outer circumferential side; a field winding that generates the magnetomotive force on passage of an electric current; and a static yoke portion that is produced so as to have an annular shape, and onto which the field winding is mounted. The stationary field rotary electric machine is disposed between the engine unit and the transmission unit such that the rotor is linked directly to an output shaft of the engine unit, and the static yoke portion is disposed inside the rotor from a side near the transmission unit such that the field winding is positioned radially inside the plurality of magnetic poles, and is held by a static member so as to be coaxial to the rotor in a stationary state.

### Effects of the Invention

According to the present invention, because the static yoke portion is disposed inside the rotor from a side near the transmission unit such that the field winding is positioned radially inside the plurality of magnetic poles and is held by the static member, heat from the engine unit is not transmitted directly to the static yoke portion. Because the static yoke portion is held in a stationary state by the static member, layers of air that are less likely to transfer heat are interposed between the rotor and the static yoke portion, suppressing heat transfer from the engine unit through the rotor to the static yoke portion. Thus, excessive temperature increases in the field winding that result from heat generated in the engine unit are suppressed.

### BRIEF DESCRIPTION OF THE DRAWINGS

FIG. 1 is a schematic diagram that shows a hybrid automobile according to Embodiment 1 of the present invention;

FIG. 2 is a partial cross section that explains a mounted state of a stationary field rotary electric machine in the hybrid automobile according to Embodiment 1 of the present invention;

FIG. 3 is a perspective that explains a construction for mounting a field winding of the stationary field rotary electric machine in the hybrid automobile according to Embodiment 1 of the present invention;

FIG. 4 is a perspective that explains a construction for mounting a field winding of a stationary field rotary electric machine in a hybrid automobile according to Embodiment 2 of the present invention;

FIG. 5 is a partial perspective that explains a construction for mounting a static yoke portion mounting pedestal of a stationary field rotary electric machine in a hybrid automobile according to Embodiment 3 of the present invention; and

FIG. 6 is a partial cross section that explains a mounted state of a stationary field rotary electric machine in a hybrid automobile according to Embodiment 4 of the present invention.

### DESCRIPTION OF EMBODIMENTS

Preferred embodiments of a hybrid automobile according to the present invention will now be explained with reference to the drawings.

### Embodiment 1

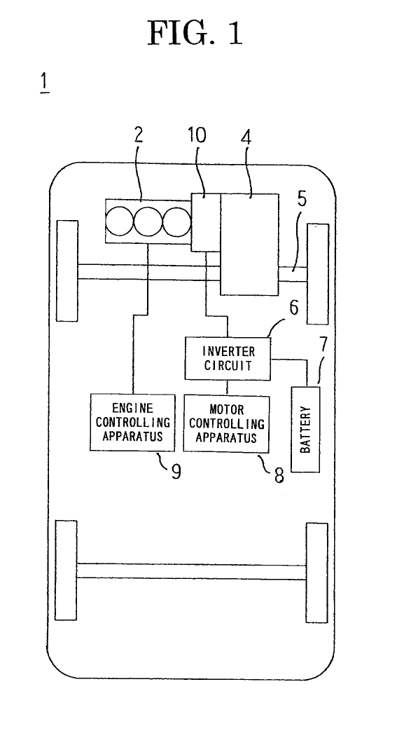

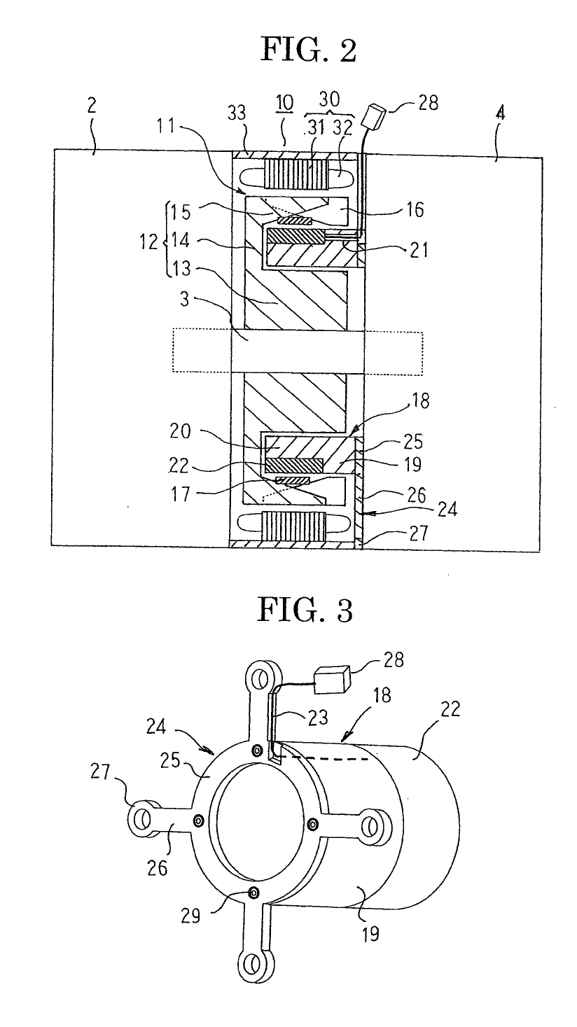

FIG. 1 is a schematic diagram that shows a hybrid automobile according to Embodiment 1 of the present invention, FIG. 2 is a partial cross section that explains a mounted state of a stationary field rotary electric machine in the hybrid automobile according to Embodiment 1 of the present invention, and FIG. 3 is a perspective that explains a construction for mounting a field winding of the stationary field rotary electric machine in the hybrid automobile according to Embodiment 1 of the present invention.

In FIG. 1, a hybrid automobile 1 includes: an engine unit 2 that generates a driving force by burning gasoline, for example; a stationary field rotary electric machine 10 that generates a driving force using electric power to assist output from the engine unit 2 and that also operates as an alternator to regenerate energy; and a transmission unit 4 that transmits driving forces from the engine unit 2 and the stationary field rotary electric machine 10 to the drive shaft 5. Here, the engine unit 2 and the stationary field rotary electric machine 10 are motive driving sources.

The stationary field rotary electric machine 10 is connected to a battery 7 by means of an inverter circuit 6. The inverter circuit 6 is driven and controlled by a motor controlling apparatus 8 such that direct-current power from the battery 7 is converted to alternating-current power, and is supplied to the stationary field rotary electric machine 10 to operate the stationary field rotary electric machine 10 as an electric motor to contribute to starting the engine unit 2 and to contribute assistance to output from the engine unit 2. Alternatively, the inverter circuit 6 is driven and controlled by a motor controlling apparatus 8 such that the stationary field rotary electric machine 10 is operated as an alternator, and alternating-current power that is generated by the stationary field rotary electric machine 10 is converted to direct-current power and is charged to the battery 7, regenerating energy. Operation of the engine unit 2 is controlled by an engine controlling apparatus 9.

Configuration of the stationary field rotary electric machine 10 will now be explained with reference to FIGS. 2 and 3.

The stationary field rotary electric machine 10 includes: a rotor 11 that is formed such that a plurality of magnetic poles that are magnetized by a magnetomotive force are arranged circumferentially on an outer circumferential side; an armature 30 that is disposed so as to surround the rotor 11 so as to have a minute gap interposed between itself and the rotor 11; a frame 33 that supports the armature 30 in a fixed state; a field winding 22 that generates the magnetomotive force on passage of an electric current; a static yoke portion 18 that holds the field winding 22; and a static yoke portion mounting pedestal 24 that holds the static yoke portion 18 in a stationary state.

The rotor 11 is a Lundell rotor that is made of a magnetic material such as iron, and includes: a rotor core 12 that has: a cylindrical boss portion 13; a thick ring-shaped yoke portion 14 that is disposed so as to extend radially outward from a first axial end of the boss portion 13; and a plurality of first claw-shaped magnetic pole portions 15 that are each disposed so as to extend from a projecting end of the yoke portion 14 toward a second axial end, and that are arranged at a uniform angular pitch circumferentially; and a plurality of second claw-shaped magnetic pole portions 16 that each extend from a second axial end toward a first axial end, and that are arranged at a uniform angular pitch circumferentially so as to intermesh with the first claw-shaped magnetic pole portions 15. The first and second claw-shaped magnetic pole portions 15 and 16 are produced so as to have a tapered shape in which radially outermost surfaces thereof have an approximately trapezoidal shape, circumferential widths become gradually narrower toward tip end portions, and radial thicknesses become gradually thinner toward the tip end portions, and constitute magnetic poles that are magnetized by the magnetomotive force. The first and second claw-shaped magnetic pole portions 15 and 16 are fixed by welding, etc., to a linking ring 17 that is made of a nonmagnetic material such as a stainless alloy and are linked integrally so as to be arranged so as to alternate circumferentially.

The static yoke portion 18 is produced using a magnetic material such as iron so as to have an annular shape that has a step-shaped cross-sectional shape in which a large diameter portion 19 and a small diameter portions 20 are disposed so as to be axially adjacent. In addition, a lead wire outlet aperture 21 is formed so as to pass axially through a radially outer side of the large diameter portion 19. The static yoke portion 18 is disposed in a recess portion that is formed by the boss portion 13, the yoke portion 14, and the first and second claw-shaped magnetic pole portions 15 and 16 such that the small diameter portion 20 is oriented toward the yoke portion 14. Here, the static yoke portion 18 is formed so as to have a shape in which minute gaps are formed between it and the boss portion 13, the yoke portion 14, and the second claw-shaped magnetic pole portion 16. The large diameter portion 19 is positioned between the boss portion 13 and the second claw-shaped magnetic pole portion 16 to configure a magnetic path between the boss portion 13 and the second claw-shaped magnetic pole portion 16.

The field winding 22 is produced by winding a conductor wire in an annular shape onto a bobbin (not shown), is mounted over the small diameter portion 20, and is fixed using an adhesive, etc., so as to be held by the static yoke portion 18.

The static yoke portion mounting pedestal 24 is produced by press-molding a flat plate of nonmagnetic metal material such as aluminum, copper, or a stainless alloy, for example, and includes: an annular base portion 25 that conforms to an end surface of the large diameter portion 19 of the static yoke portion 18; four linking portions 26 that each extend radially outward from an outer circumferential surface of the base portion 25, and that are arranged at a uniform angular pitch circumferentially; and fixing portions 27 that are formed on projecting ends of each of the linking portions 26.

The armature 30 includes: an annular armature core 31 in which a plurality of tooth portions are formed at a uniform angular pitch circumferentially such that each extend toward an inner circumferential side; and an armature winding 32 that is produced by winding conductor wire onto the tooth portions.

The frame 33 is produced by die casting aluminum, for example, so as to have a cylindrical shape.

To assemble a stationary field rotary electric machine 10 that is configured in this manner, the armature core 31 is first press-fitted into the frame 33 to mount the armature 30 integrally into the frame 33. The base portion 25 is abutted to the end surface of the large diameter portion 19 of the static yoke portion 18, and the two are fastened by screws 29 to hold the static yoke portion 18 on the static yoke portion mounting pedestal 24. The lead wire 23 of the field winding 22 is then led out through the lead wire outlet aperture 21, and is led radially outward so as to be placed alongside a linking portion 26. The connector 28 is mounted onto a leading end of the lead wire 23.

Next, a crankshaft 3, which is an output shaft of the engine unit 2, is press-fitted into a central aperture of the boss portion 13 such that the yoke portion 14 is oriented toward the engine unit 2 to link the rotor 11 directly to the crankshaft 3. The frame 33 is mounted onto the engine unit 2 in a mechanically fixed state by bolts, etc. Thus, the rotor 11 and the armature 30 are housed inside the frame 33 so as to be disposed coaxially, a minute gap is ensured between the rotor 11 and the armature 30, and the rotor 11 is linked directly to the crankshaft 3 so as to be rotatable.

The static yoke portion mounting pedestal 24 is mounted onto the transmission unit 4, which functions as a static member, by fastening the fixing portions 27 to the transmission unit 4 using screws, etc. The static yoke portion 18 is inserted into a recess portion that is formed by the boss portion 13, the yoke portion 14, and the first and second claw-shaped magnetic pole portions 15 and 16 by moving the transmission unit 4 toward the stationary field rotary electric machine 10 parallel to the axial direction of the crankshaft 3 such that the field winding 22 is positioned radially inside the first and second claw-shaped magnetic pole portions 15 and 16. The transmission unit 4 is then mounted onto the frame 33 in a mechanically fixed state by bolts, etc. The stationary field rotary electric machine 10 is thereby disposed between the engine unit 2 and the transmission unit 4.

Operation of a hybrid automobile 1 that is configured in this manner will be explained.

First, when an ignition switch (not shown) is turned to a start position, the battery voltage of the battery 7 is supplied to the field winding 22, and the inverter circuits 6 are driven and controlled by the motor controlling apparatus 8 such that the direct-current power of the battery 7 is converted to alternating-current power and is supplied to the armature winding 32. In the rotor 11, a magnetomotive force is generated on passage of an electric current to the field winding 22, magnetizing the first and second claw-shaped magnetic pole portions 15 and 16 such that North-seeking (N) poles and South-seeking (S) poles are formed so as to alternate circumferentially on the outer circumferential surface of the rotor 11. In the armature 30, the alternating current is passed through the armature winding 32, inducing predetermined magnetic poles in the armature core 31. Electromagnetic forces are generated between the magnetic poles that are induced in the armature core 31 and the magnetic poles that are formed on the outer circumferential surface of the rotor 11, starting rotation of the rotor 11. Rotation of the crankshaft 3 is thereby started, starting the engine unit 2.

When the engine unit 2 is started, the supply of alternating-current power to the armature winding 32 is stopped, and the stationary field rotary electric machine 10 is operated as an alternator. The rotor 11, which is directly connected to the crankshaft 3 of the engine unit 2, is then rotated, inducing a three-phase alternating-current voltage in the armature winding 32. Thus, the motor controlling apparatus 8 controls driving of the inverter circuits 6 to convert the three-phase alternating-current power that is induced in the armature winding 32 into direct-current power, which is supplied to the battery 7 and on-board loads.

If the accelerator is then depressed, and it is determined that an accelerating state has been entered, the stationary field rotary electric machine 10 is operated as an electric motor, and torque from the stationary field rotary electric machine 10 is added to the torque from the engine unit 2. When the rotational frequency of the engine unit 2 exceeds a predetermined value, and it is determined that the vehicle has reached a normal running state, then operation of the stationary field rotary electric machine 10 as an electric motor is stopped, and it is operated as an alternator.

The rotational torque from the crankshaft 3 is then converted at a predetermined transmission gear ratio by a transmission mechanism (not shown) of the transmission unit 4 and is transmitted to the drive shaft 5 to move the hybrid automobile 1.

Now, because the field winding 22 is mounted onto the small diameter portion 20 of the static yoke portion 18, and is disposed in the recess portion that is formed by the boss portion 13, the yoke portion 14, and the first and second claw-shaped magnetic pole portions 15 and 16, the construction is such that it is difficult to supply a cooling airflow to the field winding 22. Thus, in order to avoid excessive temperature increases in the field winding 22, it is desirable to suppress heat received by the field winding 22 from other heat-generating parts.

In Embodiment 1, a rotor 11 is linked directly to a crankshaft 3 such that a yoke portion 14 is oriented toward an engine unit 2, and a static yoke portion 18 is mounted from a side near a transmission unit 4 into a recess portion that is formed by a boss portion 13, the yoke portion 14, and first and second claw-shaped magnetic pole portions 15 and 16. Consequently, heat generated in the engine unit 2 is transferred through the rotor 11 to the static yoke portion 18 without being transferred to the static yoke portion 18 directly. Because the static yoke portion 18 is held in a stationary state, minute gaps are formed between the static yoke portion 18 and the boss portion 13, and between the static yoke portion 18 and the yoke portion 14, and layers of air that are less likely to transfer heat are present. Thus, because the amount of heat that is transferred to the static yoke portion 18 through the rotor 11 is decreased, temperature increases in a field winding 22 that result from heat generated in the engine unit 2 are suppressed.

If a lead wire 23 of the field winding 22 that is led out toward the static yoke portion mounting pedestal 24 through the lead wire outlet aperture 21 were led outside through the transmission unit 4, significant design modification of the transmission unit would be required. However, in Embodiment 1, the lead wire 23 of the field winding 22 is led out toward the static yoke portion mounting pedestal 24 through the lead wire outlet aperture 21 and is led radially outward along the static yoke portion mounting pedestal 24. Thus, because the lead wire 23 can be led out without significant design modification of the transmission unit 4, cost reductions can be achieved.

Because the static yoke portion mounting pedestal 24 includes: an annular base portion 25 that conforms to an end surface of the large diameter portion 19 of the static yoke portion 18; four linking portions 26 that each extend radially outward from an outer circumferential surface of the base portion 25, and that are arranged at a uniform angular pitch circumferentially; and fixing portions 27 that are formed on projecting ends of each of the linking portions 26, material costs can be reduced and reductions in weight can also be achieved. Thus, because the lead wire 23 is led radially outward along a linking portion 26, leading out of the lead wire 23 is facilitated.

Because the static yoke portion mounting pedestal 24 is produced using a nonmagnetic metal material, magnetic flux that is generated by the field winding 22 will not leak out through the static yoke portion mounting pedestal 24.

Because the static yoke portion mounting pedestal 24 is produced using a metal material, heat generated in the field winding 22 is radiated externally from the static yoke portion 18 through the static yoke portion mounting pedestal 24, suppressing temperature increases in the field winding 22. From a viewpoint of suppressing temperature increases in the field winding 22, it is preferable that the static yoke portion mounting pedestal 24 be produced using a metal material that has good thermal conduction such as copper, aluminum, etc.

Moreover, in Embodiment 1 above, a lead wire of a field winding is led out toward a static yoke portion mounting pedestal through a lead wire outlet aperture that is formed so as to pass through a large diameter portion of a static yoke portion, but the lead wire may also be led out through a lead wire outlet groove that is formed on an outer circumferential surface of a large diameter portion of a static yoke portion so as to have a groove direction oriented in an axial direction.

In Embodiment 1 above, a frame is produced using aluminum to reduce weight, but the material of the frame is not limited to aluminum, and the frame may also be produced using a stainless nonmagnetic metal material or a magnetic metal material such as iron.

In Embodiment 1 above, the frame is fixed to an engine unit by bolts, etc., and a transmission unit is fixed to the frame by bolts, etc., but a frame may also be interposed between an engine unit and a transmission unit and fixed integrally by bolts, etc.

### Embodiment 2

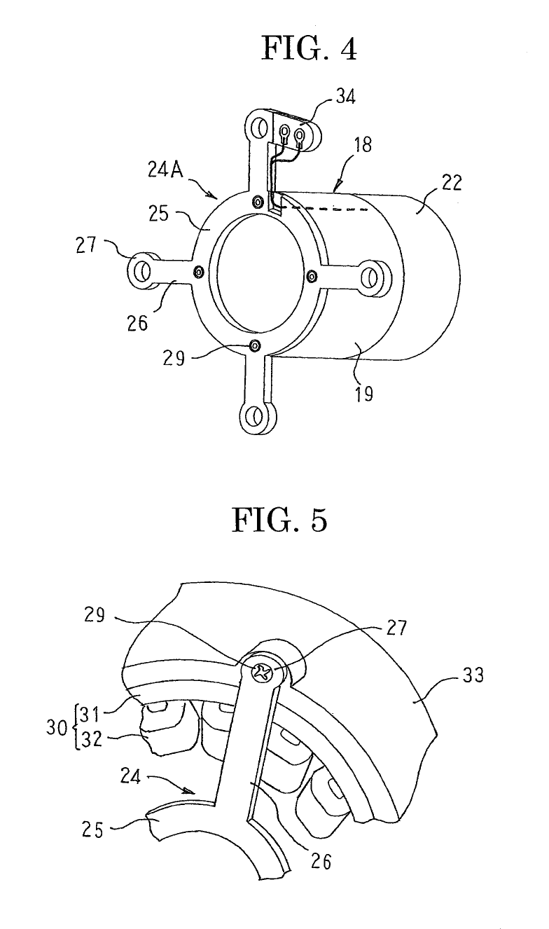

FIG. 4 is a perspective that explains a construction for mounting a field winding of a stationary field rotary electric machine in a hybrid automobile according to Embodiment 2 of the present invention.

In FIG. 4, a connecting terminal 34 that has a crimped terminal construction is formed integrally on a fixing portion 27 of a static yoke portion mounting pedestal 24A by injection molding, etc., and leading ends of a lead wire 23 that is led radially outward parallel to a linking portion 26 are connected to the connecting terminal 34.

Moreover, the rest of the configuration is configured in a similar or identical manner to that of Embodiment 1 above.

According to Embodiment 2, leading ends of a lead wire 23 that is led radially outward parallel to a linking portion 26 are connected to a connecting terminal 34 that is formed integrally on a fixing portion 27 of a static yoke portion mounting pedestal 24A. Thus, the lead wire 23 will not swing around during handling of the static yoke portion 18 that is held by the static yoke portion mounting pedestal 24A, improving workability.

### Embodiment 3

FIG. 5 is a partial perspective that explains a construction for mounting a static yoke portion mounting pedestal of a stationary field rotary electric machine in a hybrid automobile according to Embodiment 3 of the present invention.

In FIG. 5, fixing portions 27 of a static yoke portion mounting pedestal 24 are mounted in a mechanically fixed state onto a frame 33 that is a static member by screws 29, etc.

Moreover, the rest of the configuration is configured in a similar or identical manner to that of Embodiment 1 above.

According to Embodiment 3, because the static yoke portion mounting pedestal 24 is mounted onto a frame 33, the field winding 22 that is mounted onto the static yoke portion 18 and the armature 30 are mounted integrally onto the frame 33, facilitating handling, and also reducing the number of parts during assembly, thereby improving assembly.

### Embodiment 4

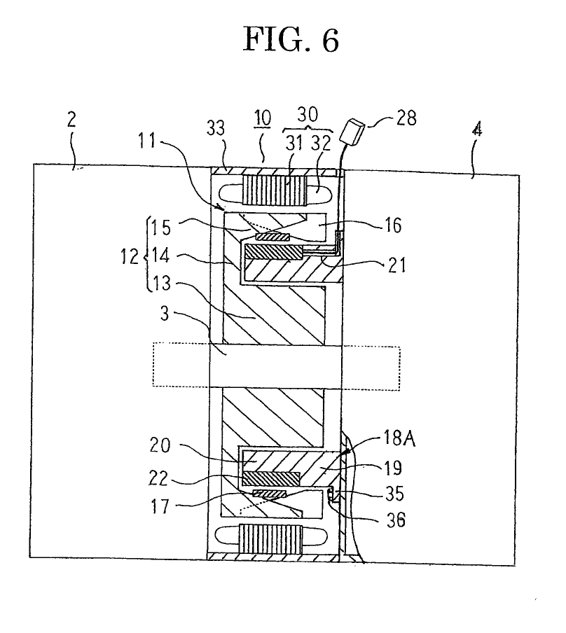

FIG. 6 is a partial cross section that explains a mounted state of a stationary field rotary electric machine in a hybrid automobile according to Embodiment 4 of the present invention.

In FIG. 6, a static yoke portion 18A has a flange portion 35 that is disposed so as to extend radially outward from a large diameter portion 19. The static yoke portion 18 is disposed in a recess portion that is formed by a boss portion 13, a yoke portion 14, and first and second claw-shaped magnetic pole portions 15 and 16 such that a small diameter portion 20 is oriented toward the yoke portion 14, and is fixed by fastening the flange portion 35 to a housing of a transmission unit 4 using screws 36.

Moreover, the rest of the configuration is configured in a similar or identical manner to that of Embodiment 1 above.

According to Embodiment 4, because the static yoke portion 18A is mounted directly onto the transmission unit 4, a static yoke portion mounting pedestal 24 is no longer required, reducing the number of parts during assembly, thereby improving assembly.

Moreover, in each of the above embodiments, first and second claw-shaped magnetic pole portions are produced so as to have tapered shapes, but the shapes of the first and second claw-shaped magnetic pole portions are not limited to tapered shapes, and may also be rectangular shapes in which a cross-sectional shape does not change in an axial direction, for example.

In each of the above embodiments, first and second claw-shaped magnetic pole portions are linked into a single body using a linking ring, but the method for fixing thereof is not limited to a linking ring provided that first and second claw-shaped magnetic pole portions that are arranged so as to alternate circumferentially can be linked and integrated.

In each of the above embodiments, a rotor is constituted by a Lundell rotor, but the rotor is not limited to being a Lundell rotor provided that the field winding is mounted into a static yoke portion and is held in a stationary state.

In each of the above embodiments, the static yoke portion 18 is produced so as to have an annular shape that has a step-shaped cross-sectional shape in which a large diameter portion and a small diameter portions are disposed so as to be axially adjacent, but the static yoke portion is not limited to having a step-shaped cross-sectional shape, provided that it includes: a winding portion for the field winding; and a magnetic path forming portion that forms a magnetic path between the boss portion of the rotor and the second claw-shaped magnetic pole portion.

1-9. (canceled)

10: A hybrid automobile, comprising:
an engine unit; and
a stationary field rotary electric machine as a motive driving source, one or both driving forces from said engine unit and said stationary field rotary electric machine being output to a drive shaft by means of a transmission unit, wherein:
said stationary field rotary electric machine comprises:
a frame;
an armature that is fixed to said frame and that is disposed inside said frame;
a rotor that is disposed inside said armature, and that is formed such that a plurality of magnetic poles that are magnetized by a magnetomotive force are arranged circumferentially on an outer circumferential side;
a field winding that generates said magnetomotive force on passage of an electric current; and
a static yoke portion that is produced so as to have an annular shape, and that is constituted by:
a large diameter portion; and
a small diameter portion onto which said field winding is mounted;
said stationary field rotary electric machine is disposed between said engine unit and said transmission unit such that said rotor is linked directly to an output shaft of said engine unit;
a radial width of said field winding is narrower than a radial width of said small diameter portion of said static yoke portion onto which said field winding is mounted; and
said static yoke portion is disposed inside said rotor from a side near said transmission unit such that said field winding is positioned radially inside said plurality of magnetic poles, an end portion of said static yoke portion near said transmission unit is mounted onto a static member by means of a static yoke portion mounting pedestal, and is held by said static member so as to be coaxial to said rotor in a stationary state.

11: The hybrid automobile according to claim 10, wherein a lead wire for passing said electric current to said field winding is led radially outward from a side of said static yoke portion near said transmission unit.

12: The hybrid automobile according to claim 10, wherein a lead wire for passing said electric current to said field winding is led radially outward by means of said static yoke portion mounting pedestal.

13: The hybrid automobile according to claim 12, wherein a connecting terminal to which a terminal of said lead wire is connected is disposed on said static yoke portion mounting pedestal.

14: The hybrid automobile according to claim 10, wherein said static yoke portion mounting pedestal comprises:
an annular base portion that holds said end portion of said static yoke portion near said transmission unit;
a linking portion that is disposed so as to extend radially outward from said base portion; and
a fixing portion that is formed on a projecting end of said linking portion, and that is fixed to said static member.

15: The hybrid automobile according to claim 14, wherein a lead wire for passing said electric current to said field winding is led out from said field winding through said static yoke portion toward said base portion, and is then led radially outward along a side surface of said linking portion.

16: The hybrid automobile according to claim 15, wherein a connecting terminal to which a terminal of said lead wire is connected is disposed on said static yoke portion mounting pedestal.

17: The hybrid automobile according to claim 10, wherein said static yoke portion mounting pedestal is produced using a nonmagnetic metal material.

18: The hybrid automobile according to claim 10, wherein said static member is said frame.

19: A hybrid automobile, comprising:
an engine unit; and
a stationary field rotary electric machine as a motive driving source, one or both driving forces from said engine unit and said stationary field rotary electric machine being output to a drive shaft by means of a transmission unit, wherein:
said stationary field rotary electric machine comprises:
a frame;
an armature that is fixed to said frame and that is disposed inside said frame;
a rotor that is disposed inside said armature, and that is formed such that a plurality of magnetic poles that are magnetized by a magnetomotive force are arranged circumferentially on an outer circumferential side;
a field winding that generates said magnetomotive force on passage of an electric current; and
a static yoke portion that is produced so as to have an annular shape, and that is constituted by:
a large diameter portion; and
a small diameter portion onto which said field winding is mounted;
said stationary field rotary electric machine is disposed between said engine unit and said transmission unit such that said rotor is linked directly to an output shaft of said engine unit;
a radial width of said field winding is narrower than a radial width of said small diameter portion of said static yoke portion onto which said field winding is mounted; and
said static yoke portion comprises a flange portion that is disposed so as to extend radially outward from said large diameter portion, is disposed inside said rotor from a side near said transmission unit such that said field winding is positioned radially inside said plurality of magnetic poles, said flange portion is mounted onto a static member, and is held by said static member so as to be coaxial to said rotor in a stationary state.

20: The hybrid automobile according to claim 19, wherein a lead wire for passing said electric current to said field winding is led radially outward from a side of said static yoke portion near said transmission unit.

21: The hybrid automobile according to claim 19, wherein said static member is said transmission unit.
